(19) United States
(12) Patent Application Publication
(10) Pub. No.: US 2014/0129614 A1
(43) Pub. Date: May 8, 2014

(54) INTEGRATING WEB ANALYTICS PRODUCTS WITH WEB CONFERENCING PRODUCTS FOR BETTER REPORTING OF USER INTERACTION AND DATA TRACKING

(71) Applicants: Bhaskar Priya, Vaibhav Khand (IN); Himanshu Sawhney, Noida (IN); Paresh Kharya, Noida (IN)

(72) Inventors: Bhaskar Priya, Vaibhav Khand (IN); Himanshu Sawhney, Noida (IN); Paresh Kharya, Noida (IN)

(73) Assignee: ADOBE SYSTEMS INCORPORATED, SAN JOSE, CA (US)

(21) Appl. No.: 13/667,933

(22) Filed: Nov. 2, 2012

(51) Int. Cl. G06F 15/16

(52) U.S. Cl. 709/203

(57) ABSTRACT

Reports may be generated by a web conferencing host from the data collected by a web analytics application by fetching reporting data from the web analytics application server and then augmenting them on a need basis at the web conferencing host server. Relevant graphs are then constructed and provided as reports to the client. For the reports, an organizer at a client machine requests the web conferencing host server to fetch the data. The web conferencing host server may query the web analytics server for the required report data, and then augment the data from the web conferencing host's own database to make the report richer, in terms of improved visualization, or improved data.

### TECHNICAL FIELD

This application relates to the technical fields of web analytics and webinar hosting.

### BACKGROUND

The term “web analytics” is the measurement, collection, analysis and reporting of Internet data for purposes of understanding and optimizing web usage. Web analytics is not merely a tool for measuring web traffic but can be used as a tool for business and market research, and to assess and improve the effectiveness of a web site. A web analytics application can also help companies measure the results of traditional print advertising campaigns, and may also help to estimate how traffic to a website changes after the launch of a new advertising campaign. Web analytics may provide information about the number of visitors to a website and the number of page views. It helps gauge traffic and popularity trends which is useful for market research.

The term “web conferencing” refers to a service that allows conferencing events to be shared with remote locations. In general the service is made possible by Internet technologies. The service allows real-time point-to-point communications as well as multicast communications from one sender to many receivers. It offers information of text-based messages, voice and video chat to be shared simultaneously, across geographically dispersed locations. Applications for web conferencing include meetings, training events, lectures, or short presentations from any computer.

### BRIEF DESCRIPTION OF DRAWINGS

Embodiments of the present invention are illustrated by way of example and not limitation in the figures of the accompanying drawings, in which like reference numbers indicate similar elements in the figures and in which:

FIG. 1 is a diagrammatic representation of a system for integrating a web analytics tool into a web conferencing system, in accordance with an example embodiment;

FIG. 2 is a swim lane flow chart illustrating a timing diagram for the system of FIG. 1, including data flow, in accordance with an example embodiment;

FIG. 3 is a screen shot of five steps of a conversion funnel fetched from the web conferencing host using a reporting API, in accordance with one example embodiment;

FIG. 3A is a flow chart illustrating the steps for the conversion funnel of FIG. 3;

FIG. 4 is screen shot illustrating a data report, such as a campaign report, in accordance with one example embodiment;

FIG. 5 is a screen shot illustrating example registration questions based on answers supplied by registrants to a webinar, in accordance with an example embodiment;

FIG. 6 is a screen shot illustrating a web analytics engagement report showing the cumulative attendance and engagement of the users in a webinar on a time axis;

FIG. 7 is a screen shot that displays a count of files downloaded by viewers in a webinar or in an advertising campaign on the Internet;

FIG. 8 is a screen shot of a web analytics poll illustrating a breakdown of poll questions answered by users during the course of a webinar, against the number of participants in the meeting; and

FIG. 9 is a diagrammatic representation of an example machine in the form of a computer system within which a set of instructions, for causing the machine to perform any one or more of the methodologies discussed herein, may be executed.

### DETAILED DESCRIPTION

Disclosed is a method and system for integrating a web analytics product, server or application with a web conferencing host, product, server or application for better reporting of user interaction and data tracking (in one embodiment campaign data tracking) while the web conferencing host is hosting a webinar, or tracking or controlling data with respect to web site visits and similar events. Meeting organizers usually try to promote the events that they are going to be organizing on various channels online/offline and would want to find out which of the promotions are resulting in maximum ROI. Each of these mediums will get its own customized URL for users to access the event from. Examples of this may be http://event.adobeconnect.com?campaign=print, which may be a URL for a print campaign, or http://event.adobeconnect.com?campaign=facebook, which may be an advertising campaign that the advertiser paid for on Facebook. One of ordinary skill in the art can devise other types of URLs. Data for ultimate use in reports may be sent from the web conferencing host to the web analytics server and organized. The data will be sent back to the web conferencing host when called for, and will be augmented for improved report visualization. Various reports may be generated by a web conferencing host from the data collected by a web analytics application. This may be accomplished by getting the reporting data from the web analytics application server and then augmenting them on need basis at the web conferencing host server, and then displaying the relevant graphs on the client side. For the reports, a client requests the web conferencing host server to get the data. The web conferencing host server may query the web analytics server for the required report data, and then augment the data from the web conferencing host's own database to make the report richer, in terms of improved visualization, or improved data. This will be discussed in more detail below.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based server and related environments, the embodiments are given merely for clarity in disclosure. Thus, any type of server environment, including various system architectures, may employ various embodiments of the application-centric resources system and method described herein and is considered as being within a scope of the present invention.

An example of a web analytic product is Omniture® SiteCatalyst™ available from Omniture, Inc, An example of a web conferencing product is Adobe®Connect™ available from Adobe® Systems, Inc. The terms “web analytic product” or “web analytic application,” and “Omniture SiteCatalyst” may be used interchangeably herein. Likewise the terms “web conferencing product,” “web conferencing host,” “web conferencing application,” “web conferencing server,” and “Adobe Connect” may be used interchangeably herein.

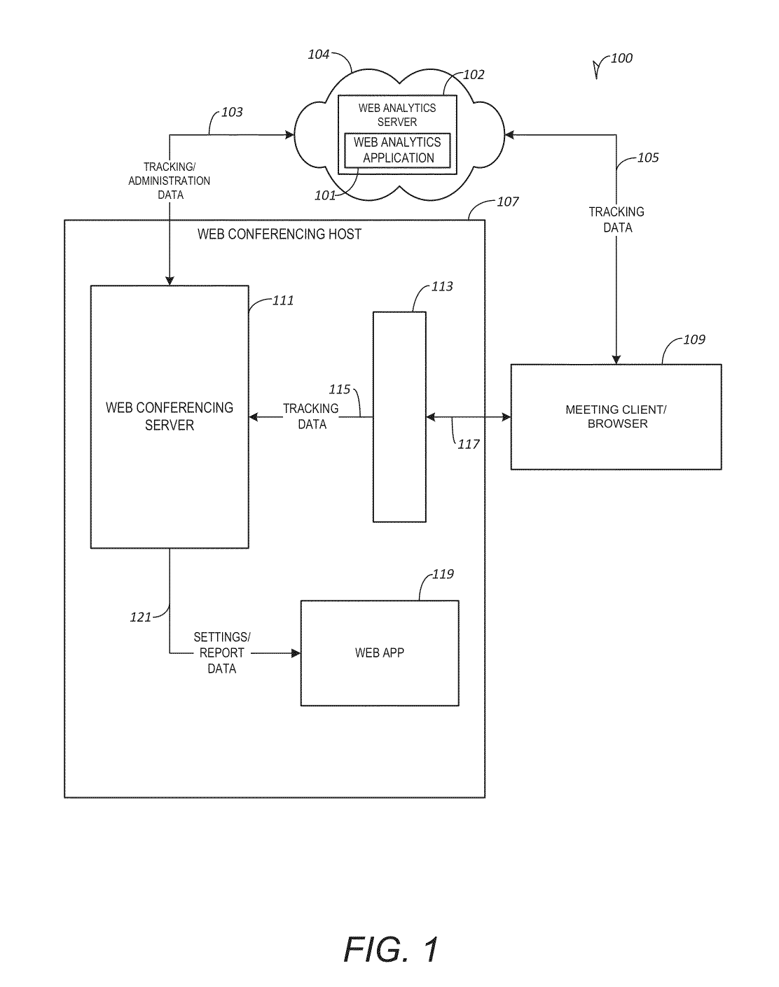

Referring now to FIG. 1, there is seen a system 100 comprising web analytics application 101, which may be in the cloud 104, and may be resident in a web analytics server 102. Discussion of functions of the web analytics server 102 herein will include functions performed by the web analytics application 101 that is included within web analytics server 102. Web analytics application 102 may be accessed by way of web analytics server 102 over the Internet or other appropriate network. An example of a web analytics application is Omniture SiteCatalyst. Web analytics application 101 may be coupled from web analytics server 102 to web conferencing server 111 by way of line 103 for tracking and administration data, inter alia, and may also be coupled to client 109 over line 105 for tracking data, inter alia. Tracking data is a set of values which define the actions taken by a user of a website and its cause. A typical tracking data for an E-Commerce website might contain the ID of the item added to the cart, age of the consumer and previous item viewed. Using these data points a marketer can find out the relation between users age and choices and present them with items they are more likely to buy. Omniture SiteCatalyst, as an example of web analytics server 102, provides two ways to make API calls over net, Simple Object Access Protocol and Representational State Transfer (REST). Adobe Connect, which is an example of a web conferencing host, uses the REST based API wherein the client application can use standard HTTP/HTTPS calls to schedule/fetch a report and get usage statistics from the web analytics application, such as SiteCatalyst, server 101 over line 105. The web conferencing host 107 may comprise web conferencing server 111, coupled to the web analytics application 101 by line 103, coupled to interface 113 by line 115. Interface 113 may be an Adobe Flash Media Server, or similar server, and its job is to keep all the clients and Web Conferencing server in sync in real time and also to allow for distribution of content over Real Time Messaging Protocol using a Secure connection RTMP(S). Web conferencing server 111 is also connected to web app 119 by line 121. Web App 119 is a web frontend of the Web Conferencing host 107 allowing the Host (organizer of an event such as a webinar) and participants to access the settings and details of the meeting/webinar before the actual webinar takes place. It serves up web pages to the visitors and allows them to register for the webinars and presents them with the schedule of upcoming webinars, if any. For the Hosts (organizers) it allows the creation scheduling, customization and management of attendees for the webinars. One or more clients 109 may also be coupled to interface 113 by way of line 117. Server 111 may be the Adobe Connect Pro Server (CPS) and interface 113, as discussed above, may comprise Adobe Flash® Media Service, which are both components of Adobe Connect.

In one embodiment web conferencing server 111 in FIG. 1 may be configured to host an event over the Internet and to receive tracking data as at 117, 113, 115, from a first client 109 that is attending the event. A web analytics server 102 may be in communication with the web conferencing server 111, the web analytics server 102 being configured to receive the tracking data as at 103 and 105. When the web conferencing server receives a request from a second client that is an organizer of the event, which may be illustrated also as 109, for a report including report data, the web conferencing server 111 requests the report data from the web analytics server 102, receives the report data from the web analytics server, augments the report data to place the report data into the report as discussed in more detail below, and transmits the report to the second client.

While sending in the tracking data from the web conferencing host server 107 to the web analytics server 102, over line 103, there may be no authentication required. The data sent in can originate from either the Client machine (users attending the meeting/webinar) 109 or from the web conferencing host 107 that is hosting the meeting/webinar. The data once sent in to the web analytics server 102 gets processed and become available for report generation. In one embodiment, as discussed above, a webinar is hosted by the web conferencing host 107 that fetches data for the reports from web analytics server 102. The data may be in report form and may be augmented by the web conferencing host for better visualization and data.

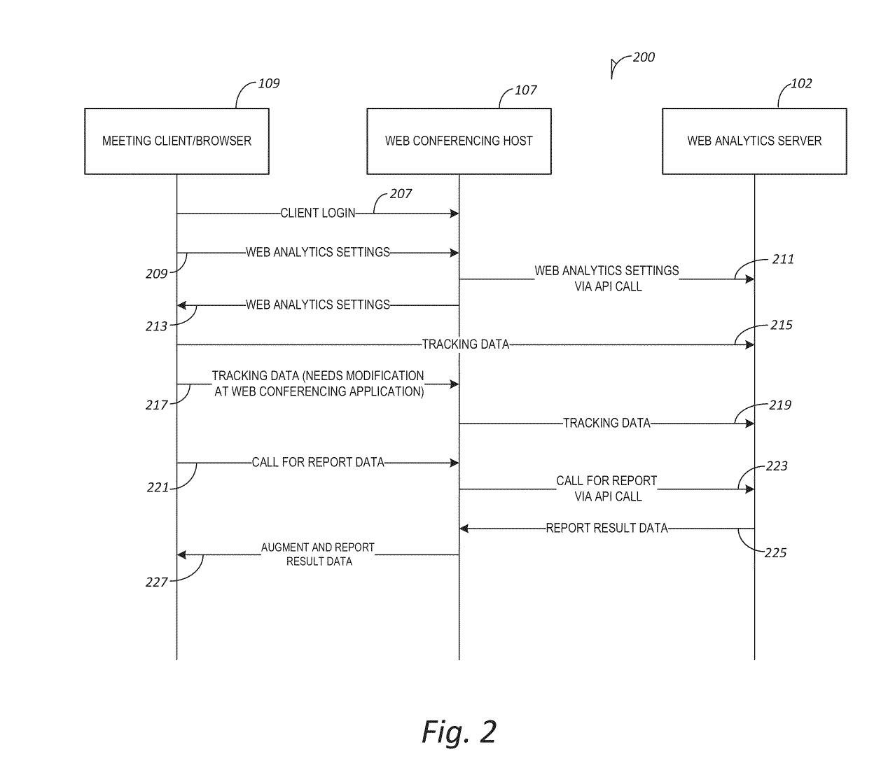

FIG. 2 is a swim lane flow chart illustrating a timing diagram 200 for the system of FIG. 1, including data flow, in accordance with an example embodiment. Client 109 may login to the web conferencing host 107 as at 207. There may be many clients 109. In some instances the clients will be parties who view a webinar advertisement. A certain percentage of these parties will access the webinar registration page, a certain percentage of these will register, and a certain number of these will attend the webinar. During the webinar certain questions may be asked. Depending on the answers to the questions the client may be determined to be a qualified prospect for marketing goods or services. In other instances the client may be the webinar organizer who may be transferring data useful in the webinar, or who may be seeking reports to determine the effectiveness of the webinar and related campaign.

For an instance in which the client is an organizer that wants to fetch reports on his or her webinar, after client log in 207 web analytics settings may be provided by the client to the web conferencing host as needed, at 209, and appropriate authentication may be managed in one embodiment by the web conferencing host 107 which, as mentioned above, may be Adobe Connect. Web analytics settings are settings related to the web analytics server 102, such as tracking server, report suite name, and the like. These web analytics settings may then be sent, by the web conferencing host 107, to the web analytics server 102 via appropriate call as at 211. As used in this context, a tracking server may be a server comprising elements that work together to collect and distribute data to users such as, in one embodiment, clients and the web conferencing host. Client specific data which does not require any modification may sent directly to web analytics server 102 from the client 109 as at 215. An example of this type of data can be a user sending a chat message. Sending the chat message is an independent activity and doesn't have any dependencies on other users so the client has all the information it needs to send out a tracking data. The web analytics settings may also be sent to the client so that for the requests that do not need any modification or intervention from the server, the client can send the tracking data directly to the web analytics tracking server. That is, the web analytics settings may also be sent, as at 213, to the client 109. Tracking data that does not need modification by the web conferencing host may be sent directly from client 109 to web analytics server 102 as at 215. A data tracking request may be considered an HTTP call where all parameters are specified. This call allows the web analytics application to gather the desired data.

Tracking data, which may need modification or augmentation by the web conferencing host 107, may be sent to the web conferencing host 107 of FIG. 2. This tracking data may be from client 109 as at 217 of FIG. 2. After modification by the web confrencing server, as needed, this data is sent from the web conferencing server 107 to the web analytics server 102 as at 219 of FIG. 2.

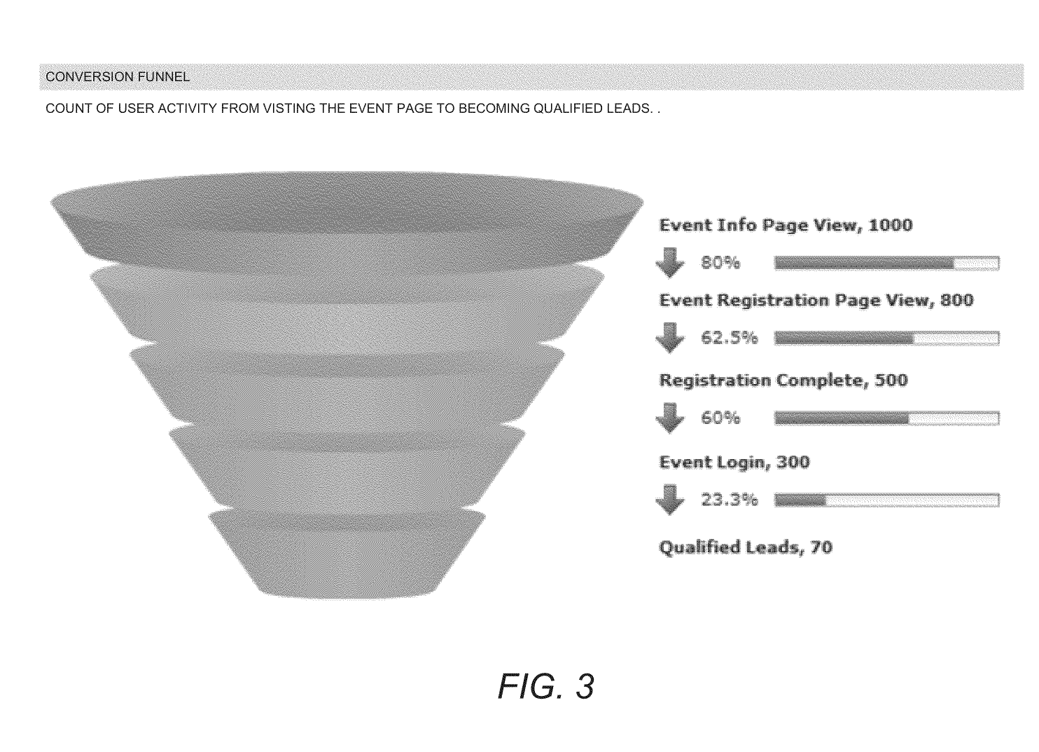

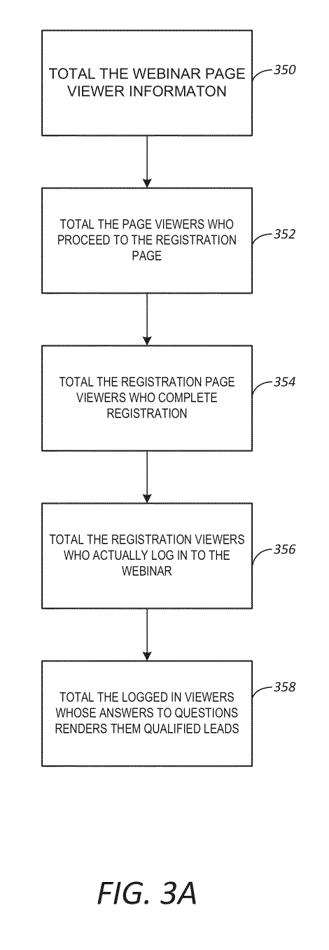

A client may call web conferencing host 107 for report data as at 221. In response, web conferencing host 107 may call web analytics server 102 for report data as at 223 of FIG. 2, with appropriate authentication as needed. The report result data is then sent, as at 225, from web analytics server 102 to web conferencing host 107, which augments the data, constructs the desired report, and then sends the desired report to the client 109 as at 227. Augmentation is discussed below with respect to FIGS. 3-8.

The above calls to generate a report as at 221 and get usage information may be protected and authentication required. The web conferencing host 107, when Adobe Connect is used, may use Representational State Transfer based authentication and for that a username and an authentication token are used. The authentication token is generated by web analytics application 101 and is stored in the web conferencing host's databases at or with respect to web conferencing host 107. Calls to the web analytics application 101 may be authenticated via username and shared secret (authentication token). To prevent replay attacks HTTP(s) requests may use a single use number that may be generated by the client 109.

As indicated above at 217, the tracking data that needs modification for report generation may be sent to web analytics server either from the individual client (people attending the meeting) 109 or the web conferencing host server (the server hosting the meeting) 107. There can be circumstances where none of the clients have complete data for the metric which needs to be tracked. In these cases each of the clients sends its part of the data to the web conferencing host server 111 which in turn sends it out to the tracking server.

There are scenarios, however, where individual client attendees cannot be entrusted with all the data required for sending a data tracking request. This can happen in case where the data required to form the data tracking request is either not available to all the clients and thus clients can never be in a position to send in the data tracking request; or the data requires some post processing and the clients cannot be counted upon to be available when the processing is complete. One example of this is the case in which a webinar meeting has polls open that users can vote in the answers and the organizer can close the poll. In one embodiment a client machine 109 is coupled to the web analytics server 102 and to the web conferencing host server 111 during a webinar hosted by the web conferencing host. A webinar organizer may create and open a poll and attendees may answer the poll. The Organizer may close the poll after some time if he/she wishes to do so. Otherwise the poll may be closed automatically when the meeting ends. If the poll is closed before the meeting ends then all the data is ready and the data tracking request can be sent across to the web analytics server 102 in FIG. 2. But in case the poll is not closed before the meeting ends then the web conferencing host server 111 may close the poll automatically. In the latter case attendees/organizers cannot be counted upon to send in the data tracking request and thus the web conferencing host server 111 would take care of sending in the data tracking request as at 219.

In another embodiment, the web conferencing host's server 111 may intervene in log out. For example, more often than not users will simply close the browser, here client 109, after attending the meeting and in such cases clients cannot be reliably counted upon for sending the logout request. When the clients disconnect the web conferencing host Server 111 sends the logout data tracking request, again as at 219.

In yet another embodiment, the web conferencing host's server may intervene in user engagement. Client 109 reports its engagement level to the web conferencing host server and this is shown to the webinar organizers. However no client has any information about the engagement level of other client participants. The aggregate meeting engagement can be calculated by the web conferencing host server 111 and thus the data tracking request for the same is managed by the web conferencing host server, again at 219.

Once the tracking data has been sent to web analytics server 102, the web analytics server processes them further and keeps them ready for report generation. The webinar organizer may request desired reports of the web conferencing host as at 221. The web conferencing host 107 may then request report data via an API call to web analytics server 102, which may normally require authentication, to request the report data as at 223 in FIG. 2. That is, the web conferencing host 107 acts as a middleman fetching the actual report data from web analytics server 102, modifying the report as requested by the organizer by web app 119 and sending it across to the organizer.

Without the coupling to, and operation of, the web conferencing host 107, the user would have to go to the web analytics application page and setup all the filters and constraints and the date ranges to get the report for a specific event. Using a web conferencing host such as, in one example embodiment, Adobe Connect, takes care of the filters and constraints that are applied to get the report for a specific event/webinar and fetches the report from the web analytics application, and augments it as requested by the client. Code examples fbr setting up the filters and constraints, and generating the needed data may be as follows.

| | | |
|---|---|---|
| Conver- | Example request parameters for | Metrics (metrics) |
| sion | getting the report. | contains the counter |
| Funnel | { | required for |
| | “reportDescription”: | generating the report. |
| | { | Date range (dateTo, |

| | |
|---|---|
| “metrics”: | dateFrom) is |
| [ | automatically |
| {“id”: | specified depending |

| | |
|---|---|
| “event11”,}, | on the configuration |

| | |
|---|---|
| {“id”: | of the webinar. |

| | |
|---|---|
| “event12”,}, | Search parameters |

| | |
|---|---|
| {“id”: | are specified based |

| | |
|---|---|
| “event13”,}, | on the Webinar. |

{“id”:

“event1”,}

],
“dateTo”: “2012-12-

16”,

“dateFrom”: “2012-05-

14”,

“reportSuiteID”:

“acnad5nfyk5tz7lm1uyx6xpyyxd2s”,

“elements”:
[
{

“id”:

“eVar1”,
“search”:

{

```
  “keywords”:
  [
  “whyonPreview : 44104”
  ],
  “type”:
  {
  “value”: “and”,
  }
```

}

}
]

}
}

Once the report is fetched from the web analytics server 102 the web conferencing host modifies the data for better visualization as requested by the client. Some type of charts may not be available from the web analytics application 101 and thus the data received from the web analytics application needs to be transformed by web conferencing host 107 so as to allow the charting. Moreover the received data can also be enhanced, if desired, using the data from the web conferencing host's databases.

Examples of the type of reporting that organizers of a webinar find important are as follows. In one example, the web conferencing host may fetch report data from the web analytics application and modify the data into a format that may be termed a “conversion funnel” in FIG. 3 for presentation to the organizer. FIG. 3 illustrates a report in the form of a funnel which is an improved visualization report as augmented by web conferencing host 107. For example, 1000 people may view an event information page, for example, an advertisement for a webinar. Of that, 800 people may view the registration page. Then 500 people may actually register, and 300 actually show up for the event login. Of those, there may 30 qualified leads. One example of a qualified lead is a person who answers a question that asks whether the person may buy a certain product within a given time period. As one example, if a person answers yes, within the next three months, that person may be categorized as a qualified lead, depending on the organizer's view, or rule set by the organizer, for determining a qualified lead. In FIG. 3, metrics for the first four steps of the conversion funnel may be fetched from the web analytics application 101 using a reporting API discussed above with respect to 223 of FIG. 2. The fifth step, however, may be a synthetic metric that is not reported to the web analytics application but computed at run time using data from the web analytics application and the web conferencing host's server's own databases subject to rule(s) set by the Meeting/Event Organizer. In this case the rules may be rules that define questions and answers that determine what a qualified lead is.

FIG. 3A is a flow chart illustrating the steps for the conversion funnel of FIG. 3. At 350 the number of viewers who access the webinar advertisement page is totalled. At 352 the number of page viewers who proceed from the advertisement page to the registration page is totalled, both in the number of viewers, and as a percentage of the viewers in 350. At 354 the number of registration page viewers that then proceed to register is totalled both as a number of viewers and as a percentage of the viewers at 352. At 356 the registered viewers who actually log in to the webinar when or after it begins is totalled, both as a number of viewers, and also as a percentage of registered viewers at 354. At 358 the total of the logged in viewers who answered questions and whose answers qualify them as qualified leads is also totalled, both as a number of viewers, and also as a percentage of the logged in viewers of 256. 258 may be a synthetic metric as mentioned above.

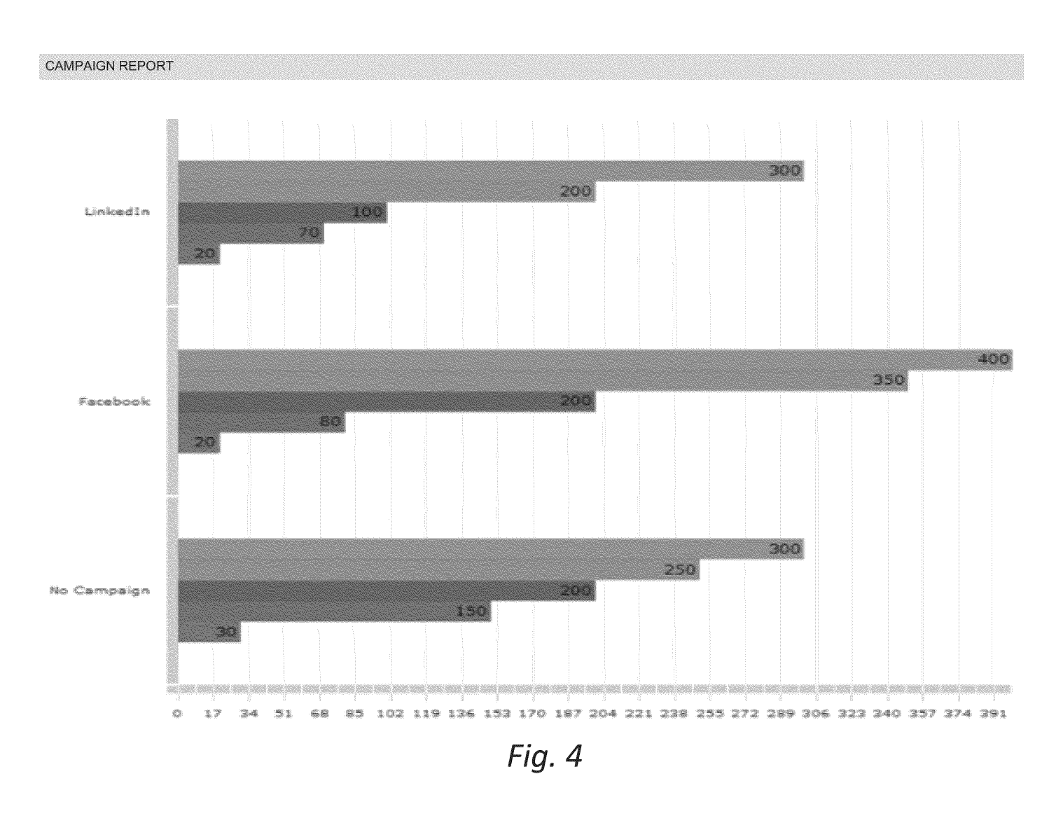

In another example, organizers may obtain a campaign report in the form of a conversion funnel seen in FIG. 4. FIG. 4 shows the effectiveness of different campaigns for the organizer's event. This report shows the breakdown of the users based on the marketing or other type of campaign the users followed in order to land up on the event pages. For example, the organizer may have advertised on a number of web sites, including LinkedIn and Facebook. The web conferencing host 107 organizes the data from web analytics application 101 into a report that shows how many viewers arrived by way of LinkedIn, by way of Facebook, and show many without any campaign. This would give the organizer insight into the effectiveness of advertizing on LinkedIn and Facebook, or not advertizing. This report is, as can be seen by comparison of FIG. 4 with FIG. 3, essentially a conversion funnel and may be computed and presented using the types of analysis discussed with respect to FIG. 3A for the conversion funnel of FIG. 3. Those of ordinary skill in the art will be able to design other reports that use the conversion funnel.

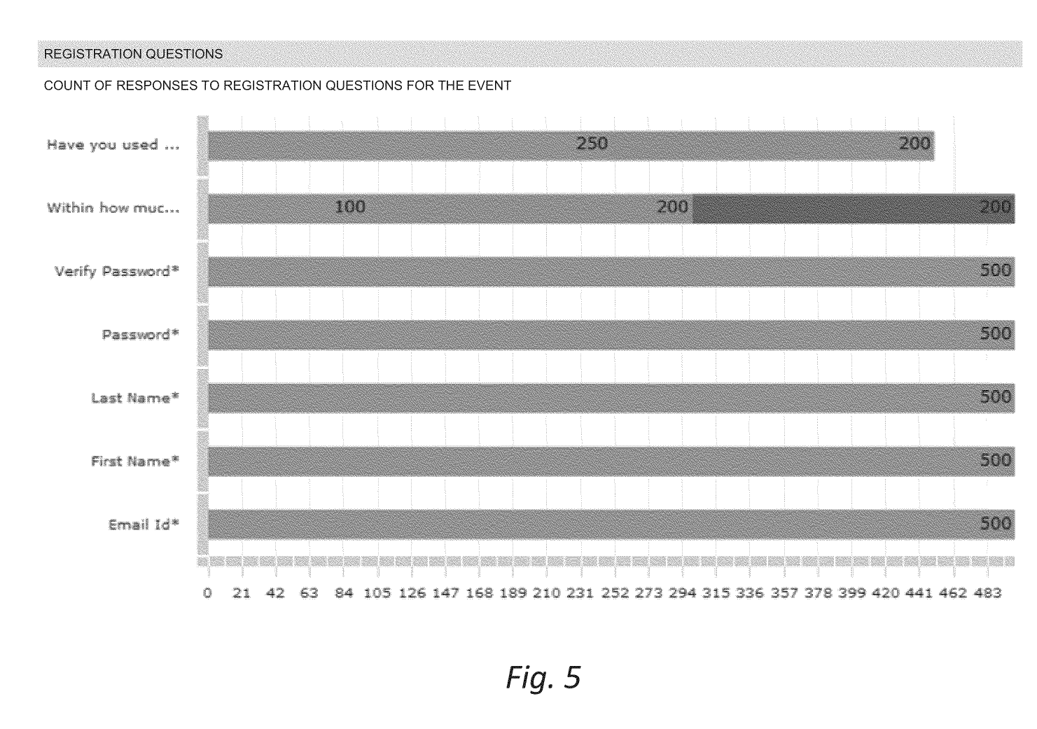

Another example report is seen in FIG. 5. In this example a report supplies a breakdown or the registration questions based on the answers supplied by the registrants. In this example, the web conference host 107 organizes data from the web analytics server 102 by how many viewers answered the question for the event. For example, these numbers may be breakups of the answers given for the questions. The full question title is available on hovering over the abbreviated question text and the individual choices are shown on hovering over the bars of the chart. For example, the first question is “Have you used Adobe Connect?” Yes: 250, No: 200. A second question, and succeeding questions, may be analyzed and presented similarly to the example for the first question.

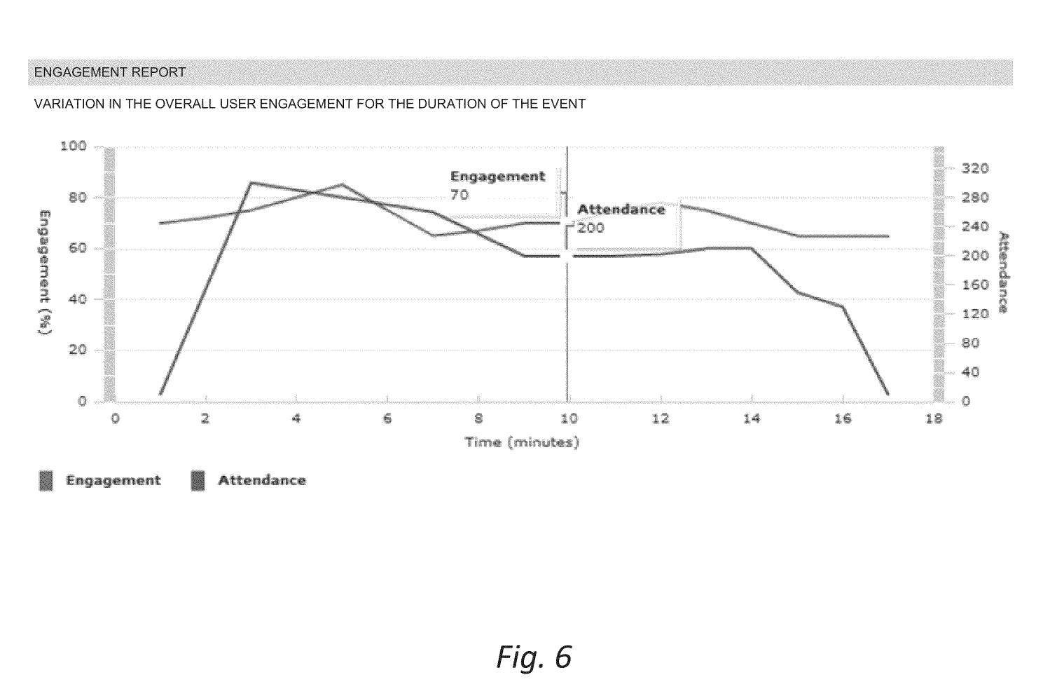

FIG. 6 is a report augmented by the web conferencing host 107 from data fetched from web analytics application 101. The report illustrates an engagement report that supplies a breakdown of the variation in the overall user engagement for the duration of the event. This shows the time based attendance and engagement values. in the illustrated case, the meeting ran for 18 minutes and on the 10th minute the attendance was 200 and the engagement was 70%.

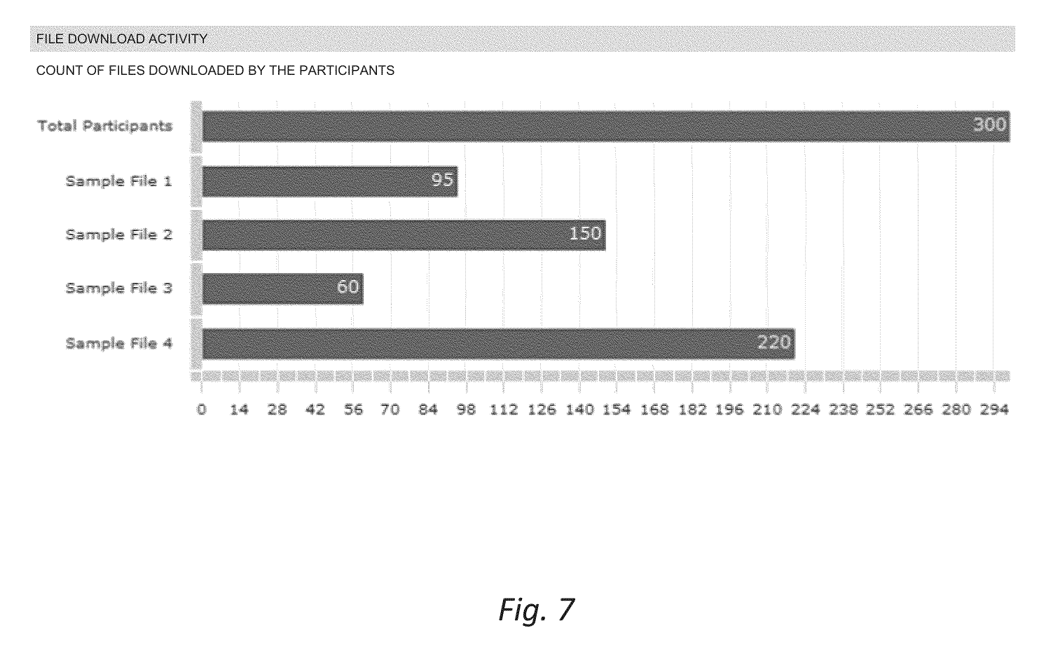

FIG. 7 illustrates a File Download Activity report that shows the number of times a file shared in a webinar or meeting was downloaded, against the number of users in the meeting. For example, Sample File 4, with 220 downloads, is the most popular type of advertisement.

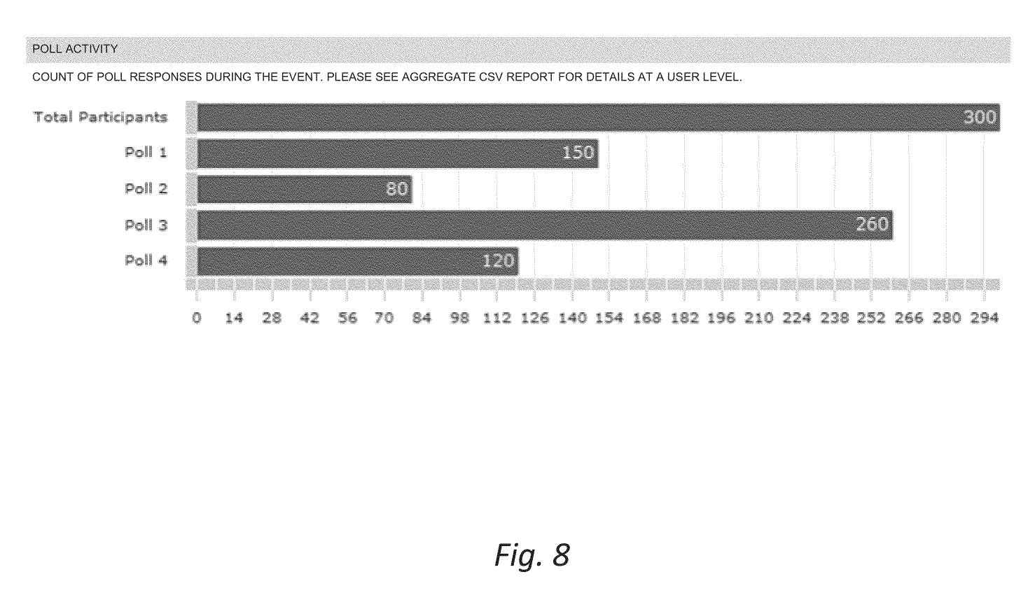

FIG. 8 illustrates a report showing poll activity. This report is a count of poll responses during the event (webinar), showing that out of a total of 300 participants, the numbers of participants who responded to Poll1, Poll2, Poll3, and Poll4.

As can be seen, each of the above reports provides the organizer insight as to the effectiveness of a given campaign, and represents market research that the organizer can use more nearly optimize his or her business campaign expenditures. The design of additional reports is well within the skill of those of ordinary skill in the art.

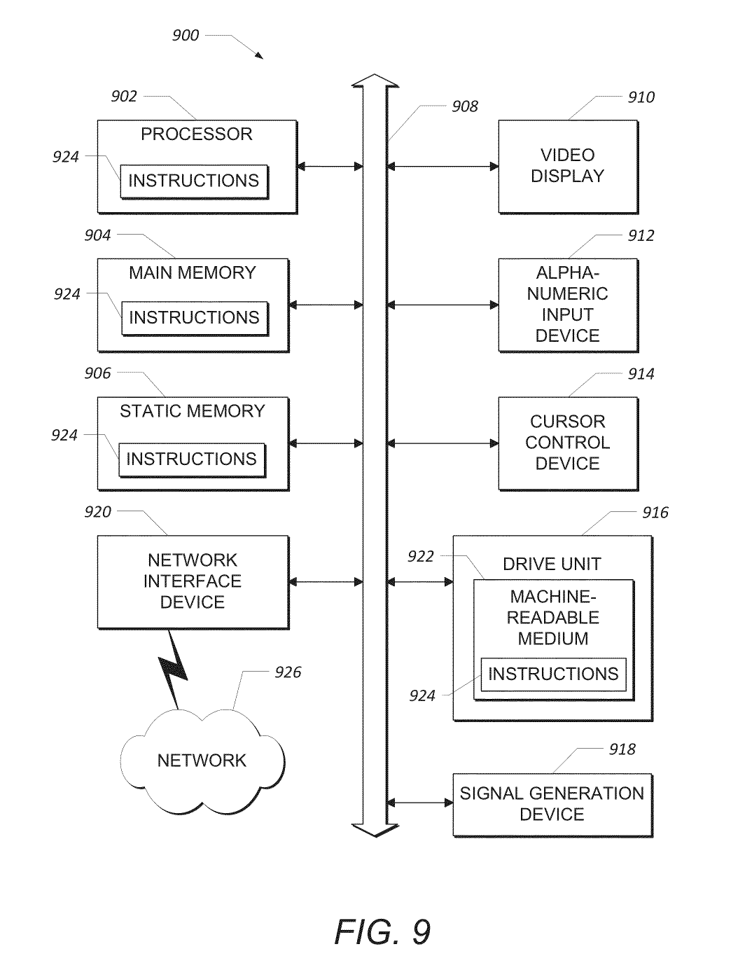

FIG. 9 shows a diagrammatic representation of a machine in the example form of a computer system 900 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904 and a static memory 906, which communicate with each other via a bus 905. The computer system 900 may further include a video display unit 910 (e.g., a liquid crystal display (LCD) or a cathode ray tube (CRT)). The computer system 900 also includes an alpha-numeric input device 912 (e.g., a keyboard), a user interface (UI) navigation device 914 (e.g., a cursor control device), a disk drive unit 916, a signal generation device 918 (e.g., a speaker) and a network interface device 920.

The disk drive unit 916 includes a machine-readable medium 922 on which is stored one or more sets of instructions and data structures (e.g., software 924) embodying or utilized by any one or more of the methodologies or functions described herein. The software 924 may also reside, completely or at least partially, within the main memory 904 and/or within the processor 902 during execution thereof by the computer system 900, with the main memory 904 and the processor 902 also constituting machine-readable media.

The software 924 may further be transmitted or received over a network 926 via the network interface device 920 utilizing any one of a number of well-known transfer protocols (e.g., Hyper Text Transfer Protocol (HTTP)).

While the machine-readable medium 922 is shown in an example embodiment to be a single medium, the term “machine-readable medium” should be taken to include a single medium or multiple media (e.g., a centralized or distributed database, and/or associated caches and servers') that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

Thus, disclosed is a method and system for integrating a web analytics product, server or application with a web conferencing host, product, server or application for better reporting of user interaction and data tracking while hosting a webinar. Although the method and system have been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense.

1. A method comprising:
receiving tracking data, by a web conferencing host that is hosting an event on the Internet, the tracking data being from a first client that is attending the event;
transmitting the tracking data from the web conferencing host to a web analytics server;
receiving, from a second client that is an organizer of the event, a request for a report including report data;
requesting report data from the web analytics server by the web conferencing host;
responsive to requesting report data, receiving the report data from the web analytics server; and
augmenting the report data to place the report data into the report and transmitting the report to the second client.

2. The method of claim 1, wherein the report format is a convergence funnel format.

3. The method of claim 1, the transmitting the tracking data comprising making an API call.

4. The method of claim 1, further comprising receiving web analytics settings by the web conferencing host and transmitting the received web analytics settings to the web analytics server.

5. The method of claim 1, the receiving a request for a report comprising receiving an API call.

6. The method of claim 1, the requesting report data from the web analytics server comprising making an API call.

7. The method of claim 1, further comprising the web conference host applying filters and constraints to fetch report data.

8. The method of claim 1, the reports comprising at least one data set from the group of data sets consisting of measured effectiveness of advertising for campaigns, measured effectiveness of not advertising for campaigns, results of responses to questions asked concerning an event, participant engagement for the duration of an event, a count of files related to the event that are downloaded by participants in the event, and a count of poll responses during the event.

9. The method of claim 1, further comprising the web conferencing host sending the data tracking request when the event participants cannot be entrusted to send the tracking data request.

10. The method of claim 1, further comprising the web conferencing host sending the web analytics sever a log out data tracking request when a client disconnects from the event.

11. The method of claim 1, further comprising the web conferencing host sending the data tracking request to the web analytics server for calculating aggregate meeting engagement by the web conferencing host.

12. A machine-readable storage device having embedded therein a set of instructions which, when executed by a web conferencing host that is hosting an event on the Internet, causes the web conferencing host to execute the following operations:
receiving tracking data from a first client that is attending the event;
transmitting the tracking data to a web analytics server;
receiving, from a second client who is an organizer of the event, a request for a report including report data;
requesting report data from the web analytics server;
receiving the report data from the web analytics server; and
augmenting the report data to place the report data into the report and transmitting the report to the second client.

13. The machine-readable storage device of claim 12 the operations further including formatting the report data into a convergence funnel format, receiving web analytics settings, and transmitting the received web analytics settings to the web analytics server.

14. The machine-readable storage device of claim 12, the report comprising at least one data set from the group of data sets consisting of measured effectiveness of advertising for campaigns, measured effectiveness of not advertising for campaigns, results of responses to questions asked concerning an event, participant engagement for the duration of an event; a count of files related to the event that are downloaded by participants in the event, and a count of poll responses during the event.

15. A system comprising:
a web conferencing server configured to host an event over the Internet and to receive tracking data from a first client that is attending the event;
a web analytics server in communication with the web conferencing server, the web analytics server being configured to receive the tracking data; and
wherein when the web conferencing server is configured to
receive a request from a second client that is an organizer of the event,
the request being for a report including report data,
request the report data from the web analytics server,
receive the report data from the web analytics server,
augment the report data to place the report data into the report, and
transmit the report to the second client.

16. The system of claim 15, the web conferencing server is configured to format the report data into a convergence funnel format.

17. The system of claim 15, the web confrencing server is configured to receive web analytics settings and transmit the received web analytics settings to the web analytics server.

18. The system of claim 15, wherein the request from the second client comprises an API call.

19. The system of claim 15, wherein the web conference server requests the report data by an API call to the web analytics server.

20. The system of claim 15, wherein the web conferencing server and web analytics server comprise the same server.
